(19) United States
(12) Patent Application Publication
(10) Pub. No.: US 2014/0322933 A1
(43) Pub. Date: Oct. 30, 2014

(54) DIRECT ATTACH CABLE INTERFACE COMPONENT, MANUFACTURING METHOD THEREOF AND DIRECT ATTACH CABLE INTERFACE DEVICE

(71) Applicant: DELTA ELECTRONICS, INC., Taoyuan Hsien (TW)

(72) Inventors: Feng LI, Taoyuan Hsien (TW); Huiliang JI, Taoyuan Hsien (TW); Jinbo ZHANG, Taoyuan Hsien (TW); Suixia ZHOU, Taoyuan Hsien (TW); Hong ZHOU, Taoyuan Hsien (TW)

(73) Assignee: DELTA ELECTRONICS, INC., Taoyuan Hsien (TW)

(21) Appl. No.: 14/259,496

(22) Filed: Apr. 23, 2014

(30) Foreign Application Priority Data
Apr. 24, 2013 (CN) 201310145608.9

(51) Int. Cl. H01R 13/66; H01R 43/20

(52) U.S. Cl. CPC H01R 13/665; H01R 43/20
USPC 439/76.1; 29/825

(57) ABSTRACT

This disclosure provides a direct attach cable interface component and device, a manufacturing method thereof. The direct attach cable interface component comprises a cable comprising multiple sub-cables inside of an coating, and a direct attach cable interface. The direct attach cable interface comprises a metal casing configured for providing a capacity space, an interface circuit board provided with a connection extension area for an electrical connection with the multiple sub-cables and disposed inside the capacity space, and an insulating attachment wrapped the connection extension area and prolonged to outside of the metal casing until covering a predetermined length of the coating of the cable, wherein the insulating attachment is consistent and made of essentially the same material and the part of multiple sub cables exposed in the metal casing is embedded in the insulating attachment.

### CROSS-REFERENCE TO RELATED APPLICATIONS

This application is based upon and claims the benefit of and the priority to Chinese Patent Application No. CN201310145608.9, filed Apr. 24, 2013, the entire contents of which are incorporated herein by reference.

### TECHNICAL FIELD

The present disclosure relates to a direct attach cable interface component, a manufacturing method thereof and a direct attach cable interface device.

### BACKGROUND

With the development of communication technology and explosive increment of user data traffic, 10 G communication network has a more common usage and larger coverage day by day. Consequently, it is required to increase Port to Port interconnecting interface of 10G equipment. There are mainly two types of Port to Port interconnecting interfaces currently, namely Fiber Cable Interface such as Active Optics Cable (AOC) and Copper Cable Interface such as Directed attached cable (DAC) interface. For the 10G Switch to Switch or Port to Port interconnection in a computer room of a data center, the DAC is widely used for its cost advantage.

Currently, the DAC is used in three ways, namely a 10G speed small form-factor pluggable (SFP+) module, a 10G speed quad small form-factor pluggable (QSFP+) module and a fan out direct attach cable interface (Fan-out) module. The Fan-out module may have different patterns, such as a fan out direct attach cable interface component with four one-channel 10G small form-factor pluggable modules branching from one 4-channel 10G small form-factor pluggable module (1QSFP+TO 4SFP+), or a fan out direct attach cable interface component with two 2-channel 10G small form-factor pluggable modules branching from one quad-channel 10G small form-factor pluggable module (1QSFP+TO 2QSFP+).

Since the DAC is used in such an environment that the communication speed is high (which in turn has a high requirement for the impedance characteristics of inner electrical connection points), the assembling density is high and the stress of cable is high, it is necessary to design the mechanical characteristics such as the engagement between the cable and the metal casing, the protection of cable bending radius, the protecting of the electrical connection points between the cable and the circuit interface board (PCB or PWB) from external impact.

As shown in FIG. 1, it is an exploded structural diagram of a conventional direct attach cable interface component. The conventional direct attach cable interface component includes a metal casing, a circuit interface board 2 disposed inside the metal casing, a cable 3 electrically connected to the circuit interface board 2 and a handle 4. The cable includes multiple sub-cables 31 and an insulating outer layer 32 wrapped around the sub-cables 31. The metal casing including an upper casing 11 and a lower casing 12 is used for protecting the circuit interface board 2. The handle 4 is used for pulling the direct attach cable interface component from other components. One end of the handle 4 is connected to the metal casing and the other end extends out of the metal casing and is provided with a pulling ring 41.

In the conventional direct attach cable interface component, the metal casing directly contact the insulating outer layer 32 of the cable 3, which makes the insulating outer layer 32 prone to wear and bend. Besides, the metal casing and the cable 3 are fixed by adhesive, as a result, the fixing strength is not enough, it is easy for the external force to pass to the pad on the circuit interface board 2 via the cable 3, which leads to the degradation of the radio frequency (RF) performance of the pad.

The above information disclosed in this Background section is only for enhancement of understanding of the background of the disclosure and therefore it may contain information that does not form the prior art that is already known in this country to a person of ordinary skill in the art.

### SUMMARY

Additional aspects and advantages will be set forth in part in the description which follows and, in part, will be apparent from the description, or may be learned by practice of the disclosure.

The present disclosure is to provide a direct attach cable interface component in which a direct attach cable interface and a metal casing are fixed tightly, as well as a manufacturing method thereof and a direct attach cable interface device.

According to one aspect of the disclosure, a direct attach cable interface component comprises a cable comprising multiple sub-cables inside of an coating, and a direct attach cable interface. The direct attach cable interface comprises a metal casing configured for providing a capacity space, an interface circuit board provided with a connection extension area for an electrical connection with the multiple sub-cables and disposed inside the capacity space, and an insulating attachment wrapped the connection extension area and prolonged to outside of the metal casing until covering a predetermined length of the coating of the cable wherein the insulating attachment is consistent and made of essentially the same material and the part of multiple sub cables exposed in the metal casing is embedded in the insulating attachment.

According to one embodiment of the present disclosure, wherein the insulating attachment comprises a recess under the edge of the metal casing.

According to one embodiment of the present disclosure, wherein the cable comprise a metal shielding mesh inside and the metal shield mesh is embedded on the surface of the recess.

According to one embodiment of the present disclosure, the direct attach cable interface component further comprises a metal sheet wrapped on the surface of the recess for electrical connection between the metal casing and the metal shielding mesh.

According to one embodiment of the present disclosure, wherein the insulating attachment is provided with a protrusion block adjacent to the recess.

According to one embodiment of the present disclosure, wherein a surface of the insulating attachment is provided with grooves in a predetermined pattern.

According to one embodiment of the present disclosure, wherein the predetermined length part of insulating attachment is provide with a predetermined shape so as to relieve external force the cable suffered.

According to one embodiment of the present disclosure, wherein the insulating attachment corresponding to the connection extension area is provided with a slope to match the metal casing.

According to one embodiment of the present disclosure, wherein the insulating attachment is essentially made of PVC.

According to one embodiment of the present disclosure, wherein an edge of the interface circuit board is provided with a notch.

According to one embodiment of the present disclosure, wherein opposite sides of the connection extension area are recessed towards each other to form two symmetrical inner contraction areas.

According to one embodiment of the present disclosure, wherein the connection extension areas is provided with at least an injection hole.

According to one embodiment of the present disclosure, wherein the connection extension area is provided with a pressure-balance recess at the edge vertical to the cable.

According to another aspect of the disclosure, A method of manufacturing a direct attach cable interface component, wherein the direct attach cable interface component comprises at least one metal casing, an interface circuit board and a cable, the method comprising the following steps:

Step S1: providing an interface circuit board with a connection extension area;

Step S2: connecting the cable with the interface circuit board;

Step S3: forming an insulating attachment wrapped from the connection extension area to a predetermined length of cable outside the metal casing;

Step S4, assembling the metal casing to provide a capacity space for the interface circuit board with the cable and the insulating attachment.

According to one embodiment of the present disclosure, the method further comprises the step of:

making a part of a metal shielding mesh of cable exposed and in a predetermined shape so as to make the part of the metal shield mesh embedded on the surface of the insulating attachment during the Step S3.

According to one embodiment of the present disclosure, the method further comprises the step of:

wrapping a metal sheet on the metal shield mesh embedded on the surface of the insulating attachment before the Step S4.

According to one embodiment of the present disclosure, wherein the Step S3 comprises two steps of:

Step S31, forming a first part of the insulating attachment;

Step S32, forming the left part of the insulating attachment.

According to one embodiment of the present disclosure, wherein the first part of the insulating attachment is from the predetermined length of the cable outside of the metal casing to a location where the cable is divided into multiple sub-cables.

According to one embodiment of the present disclosure, wherein the two steps use injection molding process.

According to one embodiment of the present disclosure, wherein the injection pressure in step S31 is larger than 70 kg/cm2, the injection pressure in step S32 is larger than 50 kg/cm2, the temperature in step S31 is higher than 120° C., and the temperature in step S32 is higher than 80° C.

According to one embodiment of the present disclosure, wherein the injection liquid is injected into a mold from side of the connection extension area in step S32.

According to one embodiment of the present disclosure, wherein step S1 the connection extension area is provided with at least one injection hole and the interface circuit board is provided with a notch.

According to one embodiment of the present disclosure, wherein step S1 the connection extension area is provided with a pressure-balance area.

According to another aspect of the disclosure, a direct attach cable interface device comprises at least one cable and at least two direct attach cable interface components as claimed in claim 1 electrically connected with two ends of the cable.

According to another aspect of the disclosure, a direct attach cable interface device comprises multiple cables and multiple direct attach cable interface components as claimed in claim 1 electrically connected with two ends of the cables.

According to one embodiment of the present disclosure, wherein one of the multiple direct attach components is electrically connected with one end of all the multiple cables.

According to one embodiment of the present disclosure, wherein the other end of all the multiple cables are connected with the direct attach cable interface components in one to one manner.

According to one embodiment of the present disclosure, the device further comprises a wire clamping ring configured for tying the multiple cables at a predetermined point.

According to one embodiment of the present disclosure, wherein the wire clamping ring moves along the cable by applying an external force to the wire clamping ring.

According to one embodiment of the present disclosure, wherein the wire clamping ring is a metal ring enclosed by a thermal shrink sleeve.

According to one embodiment of the present disclosure, the device further comprises a injection wire block configured for transition from multiple cables into another one, wherein the injection wire block is immovable.

### BRIEF DESCRIPTION OF THE DRAWINGS

The foregoing and other features and advantages of the disclosure will be apparent to those skilled in the art in view of the following detailed description, taken in conjunction with the accompanying drawings.

FIG. 1 is an exploded structural diagram showing a conventional direct attach cable interface component.

FIG. 2A is a structural schematic diagram showing the connection between the cable and the circuit interface board in the direct attach cable interface component according to the first embodiment of the disclosure.

FIG. 2B is a structural schematic diagram showing the direct attach cable interface component in the first embodiment of the disclosure in which part of the insulating attachment is disposed.

FIG. 2C is a structural schematic diagram showing the direct attach cable interface component in the first embodiment of the disclosure in which all of the insulating attachment is disposed.

FIG. 2D is a lengthwise sectional view of FIG. 2C.

FIG. 2E is a structural schematic diagram showing the assembled direct attach cable interface component in the first embodiment of the disclosure.

FIG. 2F is an exploded structural schematic diagram showing the direct attach cable interface component in the first embodiment of the disclosure.

FIG. 2G is a structural diagram of the interface circuit board in the direct attach cable interface component according to the first embodiment of the disclosure.

FIG. 3A is a structural schematic diagram showing the connection between the cable and the circuit interface board in the direct attach cable interface component according to the second embodiment of the disclosure.

FIG. 3B is a structural schematic diagram showing the direct attach cable interface component in the second embodiment of the disclosure in which part of the insulating attachment is shown.

FIG. 3C is a structural schematic diagram showing the direct attach cable interface component in the second embodiment of the disclosure in which all of the insulating attachment is shown.

FIG. 3D is a lengthwise sectional diagram of FIG. 3C.

FIG. 3E is a structural schematic diagram showing the assembled direct attach cable interface component in the second embodiment of the disclosure.

FIG. 3F is an exploded structural schematic diagram showing the direct attach cable interface component in the second embodiment of the disclosure.

FIG. 3G is a structural diagram showing of the interface circuit board in the direct attach cable interface component according to the second embodiment of the disclosure.

FIG. 4A is a front view showing the V-shaped direct attach cable interface device of the disclosure.

FIG. 4B is a top view showing the V-shaped direct attach cable interface device of the disclosure.

FIG. 4C is a back view showing the V-shaped direct attach cable interface device of the disclosure.

FIG. 5A is a front view showing the Y-shaped direct attach cable interface device of the disclosure.

FIG. 5B is a top view showing the Y-shaped direct attach cable interface device of the disclosure.

FIG. 5C is a back view showing the Y-shaped direct attach cable interface device of the disclosure.

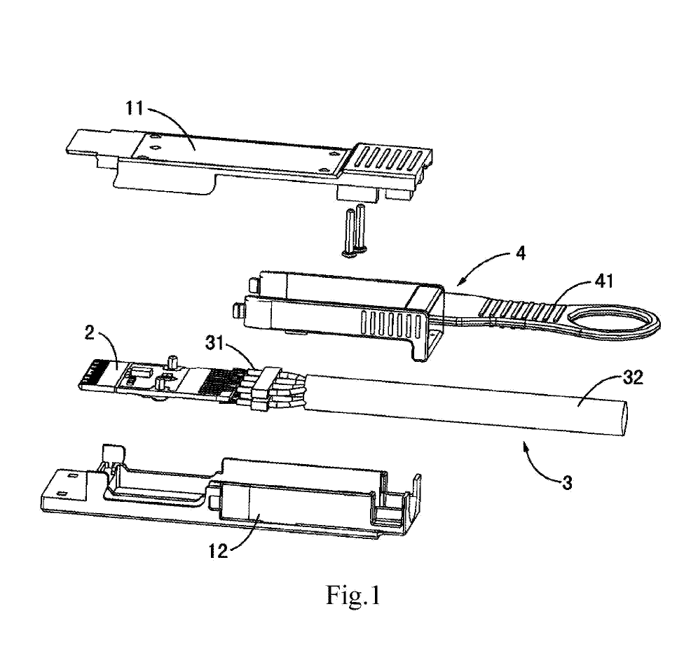

### DETAILED DESCRIPTION

Exemplary embodiments of the disclosure will now be described more fully with reference to the accompanying drawings, in which exemplary embodiments are shown.

First Embodiment of the Direct Attach Cable Interface Component

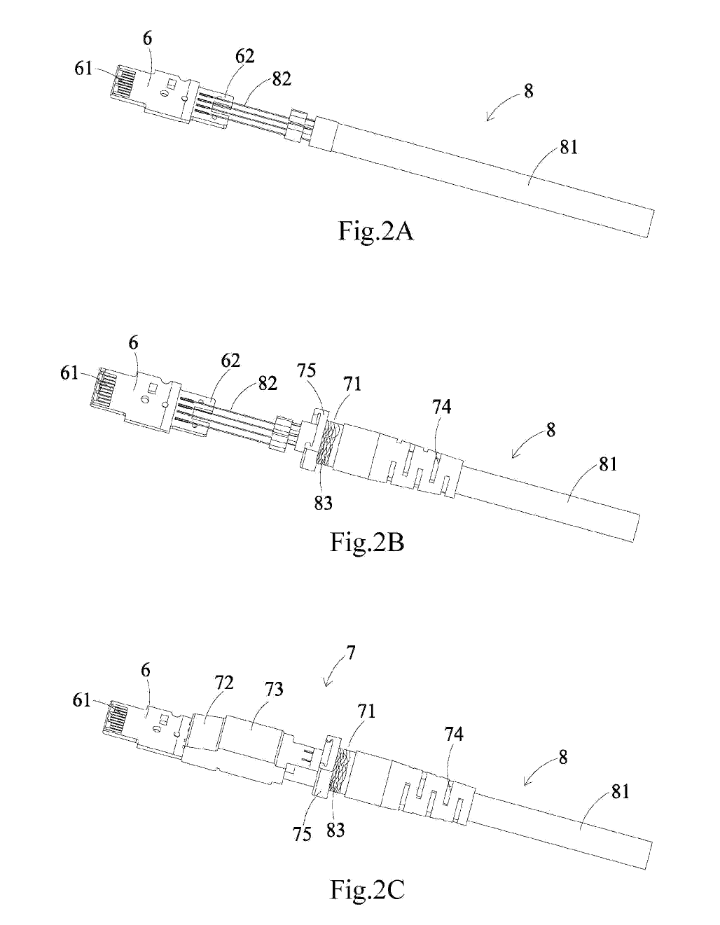

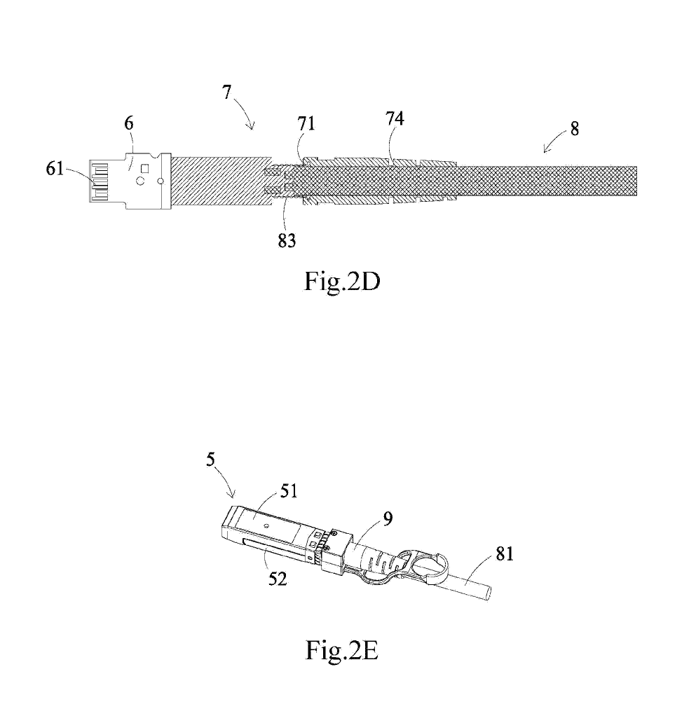

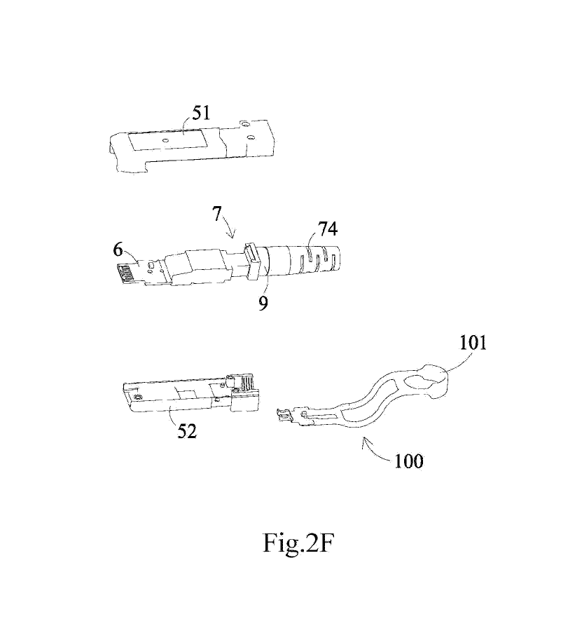

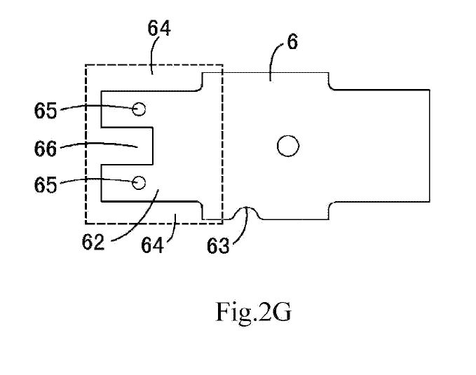

As shown in FIG. 2A to FIG. 2F, the direct attach cable interface component according to the first embodiment of the disclosure includes a direct attach cable interface and a cable 8 comprising multiple sub-cables inside of an coating. The direct attach cable interface includes a metal casing 5 configured for providing a capacity space, an interface circuit board 6, an insulating attachment 7 and a handle 100. The handle 100 is used for pulling the direct attach cable interface from other components. One end of the handle 100 is connected to the metal casing 5, and the other end extends from the metal casing 5 and has a pulling ring 101. In the embodiment, the width of the pulling ring 101 is relatively wide to make it comfortable in usage without hurting fingers.

The metal casing 5 includes an upper casing 51 and a lower casing 52 connected in a snap-fit manner or other manners. The metal casing 5 is provided with an plug opening 53 at one end.

The interface circuit board 6 is a SFP module which is disposed inside the capacity space of the metal casing 5, and an plug connection portion 61 of the interface circuit board 6 corresponds to the plug opening 53 of the metal casing 5. The other end of the interface circuit board 6 opposite to the plug opening 53 is provided with a connection extension area 62, and multiple sub-cables electrical connection points are disposed at the position adjacent to the connection extension area 62.

An edge of the interface circuit board 6 is provided with a notch 63.

The opposite sides of the connection extension area 62 are recessed towards each other to form two symmetrical inner contraction areas 64.

The connection extension areas 62 is provided with injection holes 65

The connection extension area 62 is provided with a pressure-balance recess 66 at the edge vertical to the cable.

The cable 8 includes an insulating outer layer 81 and multiple parallel sub-cables 82 wrapped by the insulating outer layer 81, and a metal shielding mesh 83 disposed between the insulating outer layer 81 and the sub-cables 82. The sub-cables 82 correspond to the sub-cable electrical connection points of the interface circuit board 6 in a one-to-one mode. The cable 8 extends out of the metal casing 5.

The insulating attachment 7 is wrapped on and fixed a predetermined length of the cable 8 exposed out of the metal casing 5 therein. The insulating attachment 7 extends towards the plug connection portion 61 of the interface circuit board 6 till it reaches the connection extension area 62 and the sub-cable electrical connection points, and is wrapped on the sub-cables 82 and fixes the sub-cables 82 therein to the insulating attachment 7 and covers the sub-cable electrical connection points.

Furthermore, the direct attach cable interface component may include a metal sheet 9 such as copper foil. The surface of the insulating attachment 7 is provided with a recess 71 and a protrusion block 75 adjacent to the recess 71. During the process of forming the insulating attachment 7, a part of the metal shielding mesh 83 of the cable 8 is embedded in the insulating attachment 7, and the other part is exposed on the surface of the recess 71. The protrusion block 75 contacts to the metal casing and facilitates setting a metal sheet 9. The metal sheet 9 is coiled around the surface of the recess 71, and is electrically connected to the metal casing 5 and the metal shielding mesh 83.

A predetermined length part of insulating attachment is provide with a predetermined shape so as to relieve external force the cable suffered, and the surface of the insulating attachment with predetermined length is provided with grooves 74. The grooves 74 may have a predetermined pattern, which may increase the flexibility of the insulating attachment.

The insulating attachment 7 corresponding to the connection extension area 62 is provided with a slope to match the metal casing. A part of the insulating attachment 7 corresponding to the sub-cables 82 is provided with an abutting part 73 abutting against two corresponding sides (such as top side and bottom side) of the metal casing 5, thereby enhancing the connecting tightness between the insulating attachment 7 and the metal casing 5. The insulating attachment 7 may be essentially made of PVC or other insulating materials.

The Method for Manufacturing the Direct Attach Cable Interface Component According to the First Embodiment

As shown in FIG. 2A to FIG. 2F, the method for manufacturing the direct attach cable interface component according to the first embodiment includes the following steps.

Step S1: providing an interface circuit board with a connection extension area 62 The connection extension area 62 may be used to increase the contact area between the interface circuit board 6 and the insulating attachment 7, thereby increasing the wrapping strength of the insulating attachment so that the interface circuit board 6 will not be easily pulled out of the insulating attachment.

For example, step S1 includes the following steps.

Step S11: providing two inner contraction areas 64 symmetrical about the center line of connection extension area 62 at two sides of the connection extension area 62, which facilitating the insulating attachment 7 being formed by covering the whole connection extension area 62. The inner contraction areas 64 may help to improve the adhesive strength between the insulating attachment 7 and the interface circuit board 6.

Step S12: making at least one injection hole 65 at the connection extension area 62. The existence of the injection hole may help to improving the material coupling between the two opposite surfaces of the insulating attachment 7 or may help balance the difference between the flow velocities of injection fluid at two opposite surfaces of the connection extension area to improve the uniformity of the insulating attachment 7. In addition, as for the SFP+ interface circuit board, the injection hole 65 is also used to allow a ground line of a parallel lines pair to run from the top side to the bottom side.

Step S13: making a notch 63 at one side of the interface circuit board 6. The notch 63 is used to prevent the operator from reversing the interface circuit board 6 in a mold during injection molding process.

Step S14, providing a pressure-balance area 66 at the connection extension area 62, the pressure-balance area 66 is used to balance the pressure of the injection molding liquid between the two opposite surfaces of the interface circuit board 6.

There is no strict order among the above steps. Or these steps could be done at one time. For example, it could use an injection molding process to make the interface circuit board 6 with all features mentioned above.

Step S2: connecting the cable with the interface circuit board.

Removing part of insulating outer layer 81 and metal shielding mesh 83 of the cable 8 inside the metal casing 5 to expose the sub-cables 82, and electrically connecting the exposed sub-cables 82 to sub-cables electrical connection points in a one-to-one mode.

Step S3: forming an insulating attachment 7 wrapped from the connection extension area to a predetermined length of the cable 8 outside the metal casing. The insulating attachment 7 may be made by an injection molding process, but it is not limited thereto. The method for manufacturing a direct attach cable interface component may further comprises a step that making a part of a metal shielding mesh of cable exposed and in a predetermined shape so as to make the part of the metal shield mesh embedded on the surface of the insulating attachment during the Step S3. During the injection molding process of forming the insulating attachment, a part of the exposed metal shielding mesh 83 is embedded in the insulating attachment 7, and the other part is exposed at the recess. Forming a metal sheet surrounding the recess and being fixed thereto and contacting the metal shielding mesh 83. The metal sheet contacts the metal casing after step S3 is performed.

Step S4: assembling the metal casing to provide a capacity space for the interface circuit board with the cable and the insulating attachment.

It may also include the step that wrapping a metal sheet on the metal shield mesh embedded on the surface of the insulating attachment before the Step S4.

In the first embodiment of the method for manufacturing the direct attach cable interface component, the connecting strength between the cable 8 and the interface circuit board 6 is enhanced by wrapping a part of the cable 8 and a part of the interface circuit board 6 with the predetermined shape of insulating attachment 7.

According to an embodiment, the insulating attachment may be manufactured in one injection molding process. However, considering the characteristic of the structure wrapped by the insulating attachment, for example, the predetermined length cable outside of the metal casing to the exposed sub-cables is substantially a column-like shape, and the part from the exposed sub-cables 82 to the sub-cable electrical connection points is substantially a sheet-like shape caused by the multiple wires exposed outside of the sub-cables, the insulating attachment may also be made by two separate injection molding processes. For example, the manufacturing of the insulating attachment may include step S31 and step S32, and the order of the two steps are not limited.

The Step S3 may conclude two steps of:

Step S31: forming a first part of the insulating attachment, the first part of the insulating attachment is from the predetermined length of the cable outside of the metal casing to a location where the cable is divided into multiple sub-cables.

Step S32: forming the left part of the insulating attachment, that is, manufacturing the insulating attachment corresponding to the part from the exposed sub-cables 82 to the sub-cable electrical connection points. In this step, the injection molding liquid may flow from the sub-cable electrical connection points to the cable 8. The injection pressure in step S31 is larger than 70 kg/cm2, such as 80 kg/cm2, the injection pressure in step S32 is larger than 50 kg/cm², such as 60 kg/cm², the temperature in step S31 is higher than 120° C., such as 130° C., and the temperature in step S32 is higher than 80° C., such as 90° C. The injection liquid is injected into a mold from side of the connection extension area in step S32. The step S31 and step S32 may use injection molding process.

Furthermore, in the case of manufacturing the insulating attachment 7 in two steps, two injection molding engage portions may be formed at the connection portions of the two parts of insulating attachment. The two injection molding engage portions could refer to the protrusion block 75. For example, one injection molding engage portion of one part of the insulating attachment is a recess connection portion with multiple recesses, and the other injection molding engage portion of the other part of the insulating attachment is a protruding bar connection portion with multiple protruding bars, which may be engaged in the recesses of the recess connection portion. The two injection molding engage portions may also be two plane portions with large areas. Since the two connected plane portions both have large areas, the connecting strength there between is increased accordingly. The two injection molding engage portions may also be an inner thread portion and an outer thread portion which cooperate with each other. Besides, the two injection molding engage portions may abut against the metal casing 5 to fix the location of the interface circuit board in the metal casing 5.

The insulating attachment is made by two different injection molding process steps according to the above embodiment. The shape of the contact area of the two injection molding engage portions which form the protrusion block 75, which are exemplified in the above, may help to improve the adhesion between the two parts of the insulting attachment, but not limit to the shape illustrated herein.

Second Embodiment of the Direct Attach Cable Interface Component

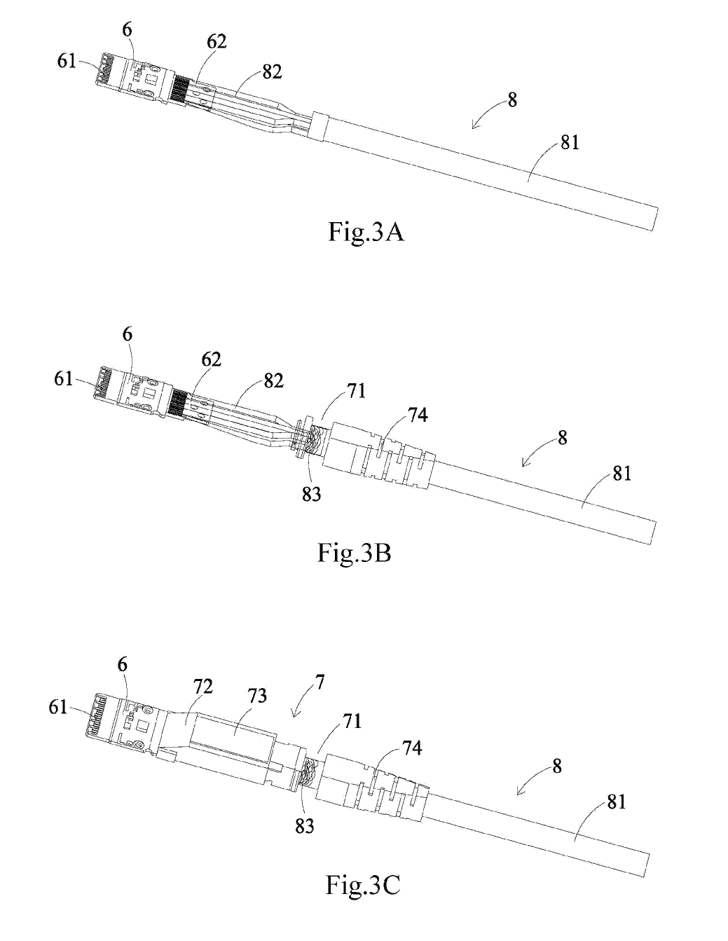

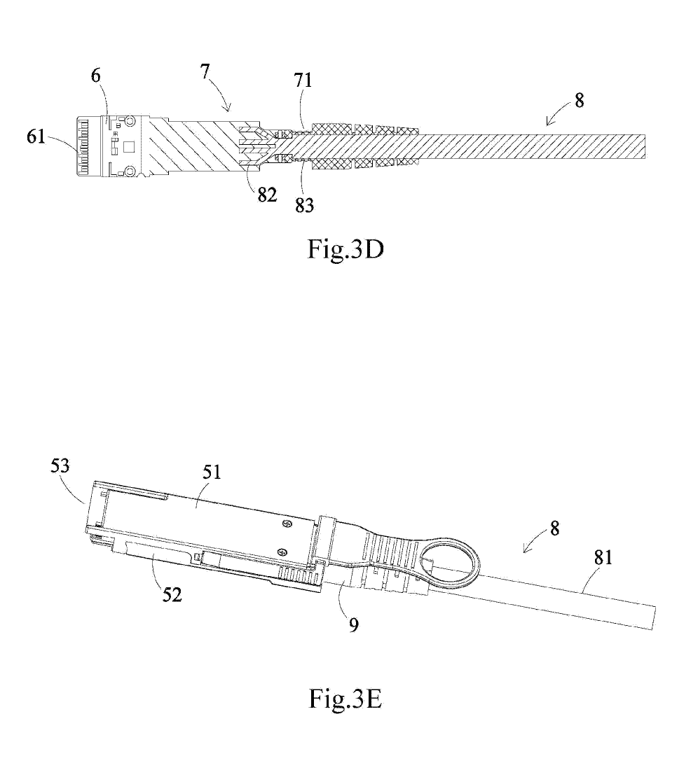

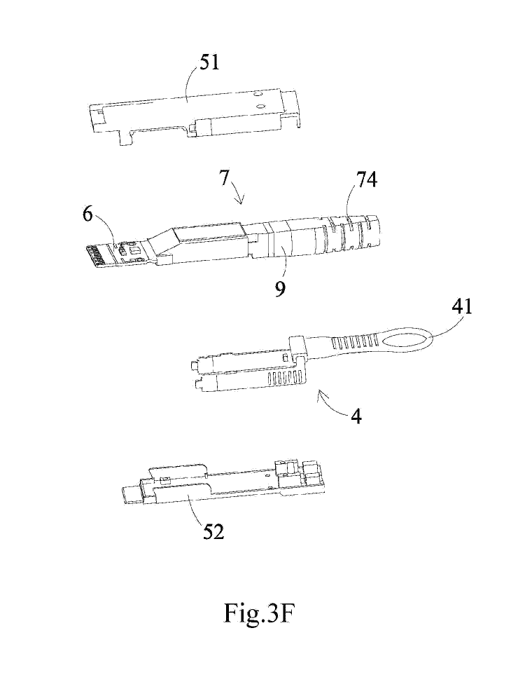

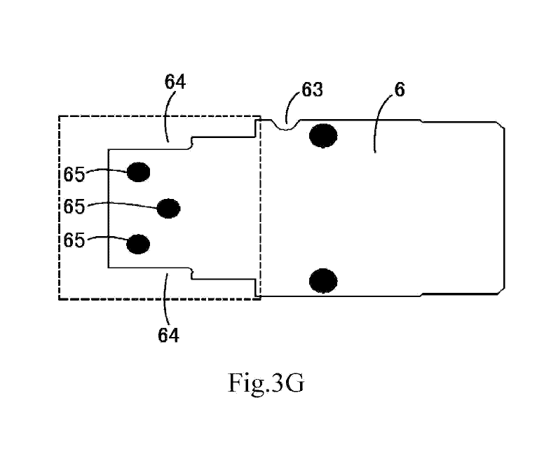

As shown in FIG. 3A to FIG. 3F, the direct attach cable interface component in the second embodiment includes a direct attach cable interface and a cable 8. The direct attach cable interface includes a metal casing 5, an interface circuit board 6, an insulating attachment 7 and a handle. The only difference between the direct attach cable interface component in the second embodiment and that in the first embodiment lies in that, the interface circuit board 6 is a QSFP, since the QSFP has a dense wiring in layout, the interface circuit board 6 is not provided with the pressure-balance area. The structure of the handle is the same as that shown in FIG. 3G, and the number of the injection holes 65 is three.

Other structures of the direct attach cable interface component in the second embodiment are similar to those in the first embodiment, and the detailed description thereof may be referenced to the above.

Method for Manufacturing the Direct Attach Cable Interface Component According to the Second Embodiment

As shown in FIG. 3A to FIG. 3F, the only difference between the method for manufacturing the direct attach cable interface component in the second embodiment and that in the first embodiment lies in that, since the QSFP has a dense wiring, the interface circuit board 6 is not provided with the pressure-balance area like the one shown in the FIG. 2G. Providing the interface circuit board 6 with the shape shown in the FIG. 3G is more preferable for the interface circuit board connected with high density wires in the cable. Of course, the connection extension area is not limited to the examples illustrated here. The shapes of the connection extension area help to accomplish the manufacture of the insulating attachment by the injection molding process should be all included.

Other steps in method for manufacturing the direct attach cable interface component according to the second embodiment are basically the same as those in the method for the first embodiment, and the detailed description thereof may be referenced to the above.

Direct Attach Cable Interface Device

The direct attach cable interface device of the disclosure includes multiple cables and multiple direct attach cable interfaces. One end of the cable is connected to one direct attach cable interface, and the other end is connected to at least one direct attach cable interface. The structure of the cable, the structure of the direct attach cable interface and the connecting way between the cable and the direct attach cable interface are the same as the direct attach cable interface component illustrated above, and the detailed description thereof may be referenced to the above.

In an embodiment of the direct attach cable interface device, two ends of the cable are connected to a direct attach cable interface component, respectively. The direct attch cable interface component could be a SFP, a QSFP and so on.

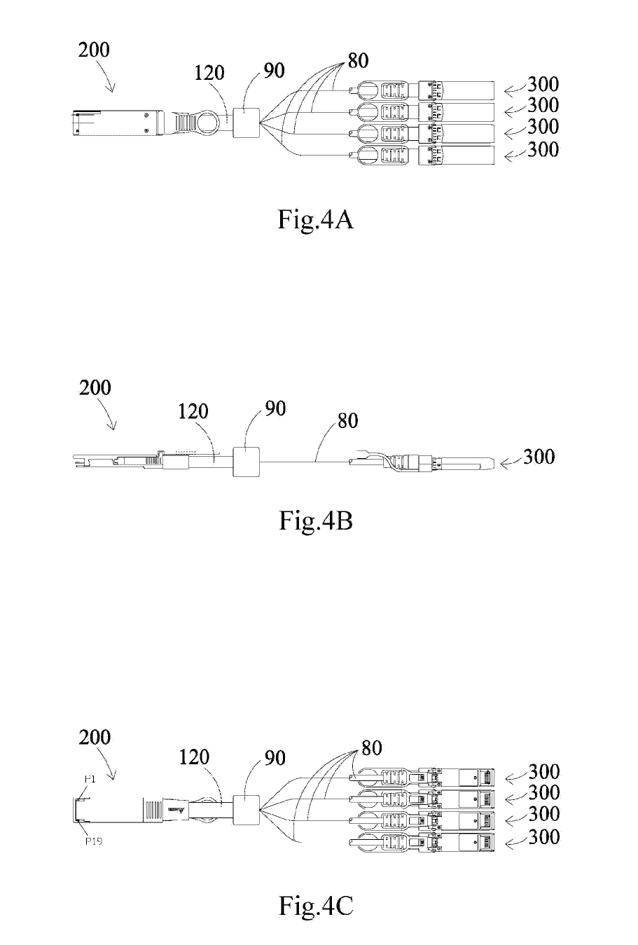

In another embodiment of the direct attach cable interface device, the device comprises multiple cables and multiple direct attach cable interface components electrically connected with two ends of the cables. The multiple direct attach cable interface components electrically connected with two ends of the cables. As shown in FIG. 4A, FIG. 4B and FIG. 4C, which show a Y-shape direct attach cable interface device, one end of the cable is connected to a QSFP 200, and the other end is connected to multiple SFPs 300 such as four SFPs. Each of the SFPs is connected to a branch-cable 80, and the branch-cables 80 are gathered at the insulating attachment exposed from the metal casing of the QSFP, and the Y-shape direct attach cable interface device also includes an injection wire block 90 for tying the branch-cables 80. The injection wire block 90 is kind of transition from multiple cables into another one and is immovable. As shown in FIG. 4A, FIG. 4B and FIG. 4C, one side of the injection wire block 90 has multiple cables and other side of the injection wire block 90 has only one cable. The only cable has a wire tube 120 contained all the multiple cables from the other side.

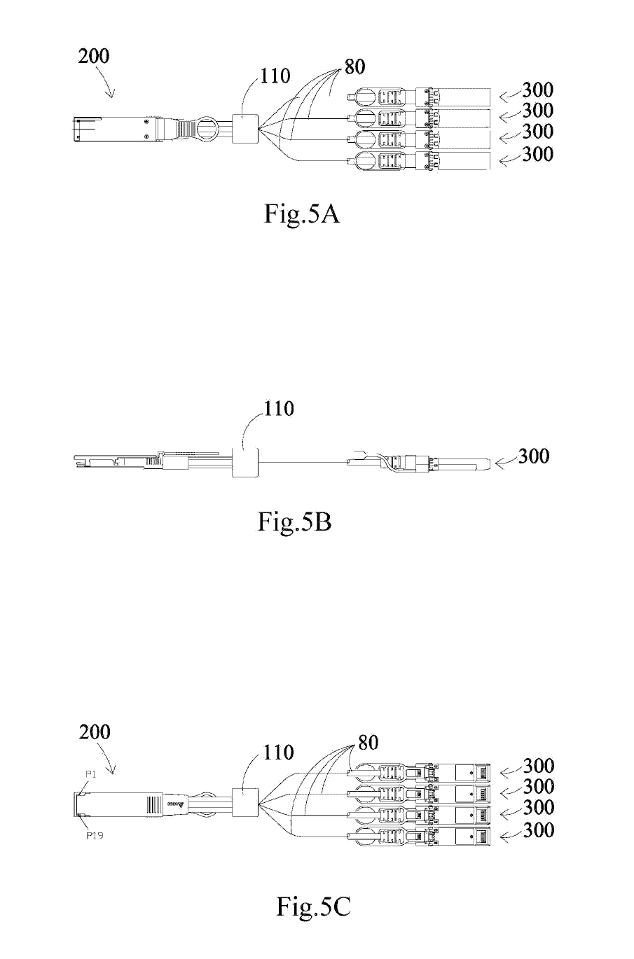

As shown in FIG. 5A, FIG. 5B and FIG. 5C, which show a V-shape direct attach cable interface device, one end of the cable is connected to a QSFP 200, and the other end is connected to multiple SFPs 300, for example four SFPs, each of the SFPs is connected to a branch-cable 80, and the branch-cables 80 are gathered at the position where the insulating attachment exposed from the metal casing of the QSFP. At the gathering point, there is also an injection wire block close to the insulating attachment or the injection wire block is part of the insulating attachment. The direct attach cable interface device further comprises a wire clamping ring 110. The wire clamping ring is a metal ring enclosed by a thermal shrink sleeve. The wire clamping ring 110 could moves along the cables by applying an external force to the wire clamping ring 110.

Method for Manufacturing the Direct Attach Cable Interface Device

With reference to FIG. 3A to FIG. 3F, the difference between the method for manufacturing the direct attach cable interface device and the method for manufacturing the direct attach cable interface component is described now.

In case that the direct attach cable interface device is a V-shaped direct attach cable interface device. For this kind of direct attach cable interface device the predetermined length of the insulating attachment is different from the content illustrated above. The predetermined length of the insulating attachment is more like an injection wire block for changing the branch cables 80 into one cable. Therefore, the branch-cables 80 may be processed as follows: removing the insulating outer layer of the branch-cable 80 at the position adjacent to the metal casing to make the total outer diameter of all branch-cables 80 less than 8 mm, and then forming a 3-4 mm long plastic block in the injection molding process at the position where the insulating outer layer is removed, thereby solving the problem of having a too small opening diameter of the metal casing 5 and the problem of having difficulty to tie the branch-cables into a cable. The length of the plastic block may be adjusted according to practical requirement.

To improve the strength of tying branch-cables into a cable, a metal ring may be sleeved on the branch-cables, and then a thermal-shrink sleeve may be used to enclose the metal ring to form the wire clamping ring 110. The wire clamping ring 110 may be fixed to a certain position without moving, or may also be movable along the branch-cables under an external force. Alternatively, the metal ring may also be exposed directly without being enclosed by a thermal-shrink sleeve, by which the manufacturing cost is reduced. In this case, the metal ring can slide along the branch-cables.

In case that the direct attach cable interface device is a Y-shaped direct attach cable interface device, the branch-cables 80 may be processed as follows: removing the insulating outer layer of the branch-cables 80 at one side of the injection wire block; sleeving a wire tube 120 such as a plastic flexible tube or other like tubes onto the branch-cables 80 at the position where the insulating outer layer is removed, and then forming the injection wire block at the end of the wire tube 120 in the injection molding process. Then it could realize to change the branch-cables 80 in to one cable.

Other steps of the method for manufacturing the direct attach cable interface device are the same as those for manufacturing the direct attach cable interface component, and the detailed description thereof may be referenced to the above.

It should be noted that the above embodiments are only illustrated for describing the technical solution of the disclosure and not restrictive, and although the embodiments are described in detail by referring to the aforesaid embodiments, those skilled in the art should understand that the aforesaid embodiments can be modified and portions of the technical features therein may be equally changed, which does not depart from the spirit and scope of the technical solution of the embodiments of the disclosure.

The disclosure has following beneficial advantages:

The direct attach cable interface component or device has much better mechanic test result compared with the same product in the market. The insulating attachment covers the structure from a predetermined length of cable outside the metal casing to the sub-cable electrical connection points of the interface circuit board (including the sub-cable electrical connection points), as a result, the connection strength between the interface circuit board and the cable is improved effectively.

What is claimed is:

1. A direct attach cable interface component, comprising:
a cable comprising multiple sub-cables inside of an coating;
a direct attach cable interface, comprising:
a metal casing configured for providing a capacity space;
an interface circuit board provided with a connection extension area for an electrical connection with the multiple sub-cables and disposed inside the capacity space; and
an insulating attachment wrapped the connection extension area and prolonged to outside of the metal casing until covering a predetermined length of the coating of the cable, wherein the insulating attachment is consistent and made of essentially the same material and the part of multiple sub cables exposed in the metal casing is embedded in the insulating attachment.

2. The direct attach cable interface component according to claim 1, wherein the insulating attachment comprises a recess under the edge of the metal casing.

3. The direct attach cable interface component according to claim 2, wherein the cable comprise a metal shielding mesh inside and the metal shield mesh is embedded on the surface of the recess.

4. The direct attach cable interface component according to claim 3, further comprising a metal sheet wrapped on the surface of the recess for electrical connection between the metal casing and the metal shielding mesh.

5. The direct attach cable interface component according to claim 2, wherein the insulating attachment is provided with a protrusion block adjacent to the recess.

6. The direct attach cable interface component according to claim 1, wherein a surface of the insulating attachment is provided with grooves in a predetermined pattern.

7. The direct attach cable interface component according to claim 1, wherein the predetermined length part of insulating attachment is provide with a predetermined shape so as to relieve external force the cable suffered.

8. The direct attach cable interface component according to claim 1, wherein the insulating attachment corresponding to the connection extension area is provided with a slope to match the metal casing.

9. The direct attach cable interface component according to claim 1, wherein the insulating attachment is essentially made of PVC.

10. The direct attach cable interface component according to claim 1, wherein an edge of the interface circuit board is provided with a notch.

11. The direct attach cable interface component according to claim 1, wherein opposite sides of the connection extension area are recessed towards each other to form two symmetrical inner contraction areas.

12. The direct attach cable interface component according to claim 1, wherein the connection extension areas is provided with at least an injection hole.

13. The direct attach cable interface component according to claim 1, wherein the connection extension area is provided with a pressure-balance recess at the edge vertical to the cable.

14. A method for manufacturing a direct attach cable interface component, wherein the direct attach cable interface component comprises at least one metal casing, an interface circuit board and a cable, the method comprising the following steps:
Step S1: providing an interface circuit board with a connection extension area;
Step S2: connecting the cable with the interface circuit board;
Step S3: forming an insulating attachment wrapped from the connection extension area to a predetermined length of cable outside the metal casing;
Step S4, assembling the metal casing to provide a capacity space for the interface circuit board with the cable and the insulating attachment.

15. The method of claim 14, further comprising:
making a part of a metal shielding mesh of cable exposed and in a predetermined shape so as to make the part of the metal shield mesh embedded on the surface of the insulating attachment during the Step S3.

16. The method of claim 15, further comprising:
wrapping a metal sheet on the metal shield mesh embedded on the surface of the insulating attachment before the Step S4.

17. The method of claim 14, wherein the Step S3 comprises two steps of:
Step S31, forming a first part of the insulating attachment;
Step S32, forming the left part of the insulating attachment.

18. The method of claim 17, wherein the first part of the insulating attachment is from the predetermined length of the cable outside of the metal casing to a location where the cable is divided into multiple sub-cables.

19. The method of claim 17, wherein the two steps use injection molding process.

20. The method of 19, wherein the injection pressure in step S31 is larger than 70 kg/cm², the injection pressure in step S32 is larger than 50 kg/cm², the temperature in step S31 is higher than 120° C., and the temperature in step S32 is higher than 80° C.

21. The method of claim 19, wherein the injection liquid is injected into a mold from side of the connection extension area in step S32.

22. The method of claim 14, wherein step S1 the connection extension area is provided with at least one injection hole and the interface circuit board is provided with a notch.

23. The method of claim 14, wherein step S1 the connection extension area is provided with a pressure-balance area.

24. A direct attach cable interface device comprising:
at least one cable;
at least two direct attach cable interface components as claimed in claim 1 electrically connected with two ends of the cable.

25. A direct attach cable interface device comprising:
multiple cables;
multiple direct attach cable interface components as claimed in claim 1 electrically connected with two ends of the cables.

26. The device of claim 25, wherein one of the multiple direct attach components is electrically connected with one end of all the multiple cables.

27. The device of claim 26, wherein the other end of all the multiple cables are connected with the direct attach cable interface components in one to one manner.

28. The device of claim 25, further comprising a wire clamping ring configured for tying the multiple cables at a predetermined point.

29. The device of claim 28, wherein the wire clamping ring moves along the cables by applying an external force to the wire clamping ring.

30. The device of claim 29, wherein the wire clamping ring is a metal ring enclosed by a thermal shrink sleeve.

31. The device of claim 25, further comprising a injection wire block configured for transition from multiple cables into another one, wherein the injection wire block is immovable.
